(19) United States
(12) Patent Application Publication
(10) Pub. No.: US 2004/0090648 A1
(43) Pub. Date: May 13, 2004

(54) Systems and methods for controlling imaging device configuration

(76) Inventors: Brett Green, Meridian, ID (US); Daniel Travis Lay, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/292,719

(22) Filed: Nov. 12, 2002

(51) Int. Cl. G06F 15/00; G06K 1/00

(52) U.S. Cl. 358/1.15; 358/1.13

(57) ABSTRACT

Disclosed are systems and methods for controlling imaging devices. In one embodiment, a system and a method pertain to querying the imaging device for configuration information, receiving the configuration information from the imaging device, comparing the configuration information to a master profile for the imaging device, and determining if there are any discrepancies between the configuration information and information contained in the master profile.

### FIELD OF THE DISCLOSURE

The present disclosure relates to controlling imaging devices. More particularly, the disclosure relates to systems and methods for evaluating and changing, if necessary, the configuration of imaging devices.

### BACKGROUND

Often times, imaging devices such as printers and photocopiers, are used together in groups. For example, several imaging devices may be grouped together in a test center to test the printing capabilities of the imaging devices. To cite another example, several imaging devices may be used together in a printing pool of a large entity, such as a corporate enterprise, to receive the print jobs of many different users. In either scenario, the imaging devices are normally identical in make and model.

Imaging devices of a given group are normally maintained so as to have the same configurations. In the testing context, this permits the technician to more easily identify firmware and/or print driver defects. In the printing pool context, identical configuration of the imaging devices ensures that similar print results will be obtained regardless of which imaging device actually receives and processes the print job. Even where identical imaging devices are not used in a printing pool, it still may be desirable to use particular device configurations so that the output of the various imaging devices, regardless of type, are substantially identical.

Several settings of most imaging devices may be adjusted by users via a front menu panel provided on the device or, where the imaging device comprises an embedded network server, via one or more network pages to which users may browse. If a user makes a setting change on one of the imaging devices of a given group, the configurations of the devices will no longer match, thereby creating problems in both the testing and printing pool scenarios. In such circumstances, an administrator (e.g., technician or information technology (IT) professional) typically must manually evaluate and possibly reconfigure the imaging devices to ensure that each has the desired configuration.

To evaluate the imaging devices of a group, an administrator must first locate an imaging device having the correct configuration. Typically, this is done by printing a configuration page that identifies the configuration (i.e., state) of the imaging device. If, after examining the configuration page, the administrator determines that the configuration of the imaging device to be correct, the administrator must then print out configuration pages for each of the other imaging devices of the group, and then compare those pages with the initially printed page, which may be considered to reflect the master profile. If, through this comparison, it is determined that the configuration (e.g., settings) of one or more of the imaging devices is incorrect, the administrator must then manually reconfigure the devices. After all changes have been made, the administrator must again print out configuration pages for each imaging device and reevaluate them to ensure that each imaging device is now correctly configured.

As can be appreciated from the above description, the inspection/reconfiguration process is manually intensive. Unfortunately, this process may need to be performed several times a day in that one or more settings may be changed by a user at any time. It is therefore understandable that the repetition of the inspection/reconfiguration process can be very frustrating for the administrator.

### SUMMARY OF THE INVENTION

Disclosed are systems and methods for controlling imaging devices. In one embodiment, a system and a method pertain to querying the imaging device for configuration information, receiving the configuration information from the imaging device, comparing the configuration information to a master profile for the imaging device, and determining if there are any discrepancies between the configuration information and information contained in the master profile.

Optionally, the systems and methods can be used to evaluate and reconfigure imaging devices of a group of imaging devices.

### BRIEF DESCRIPTION OF THE DRAWINGS

The systems and methods can be better understood with reference to the following drawings. The components in the drawings are not necessarily to scale.

FIG. 1 is a schematic view of an embodiment of a system through which imaging device configuration can be controlled.

FIG. 2 is a block diagram of an embodiment of a central computing device shown in FIG. 1.

FIG. 3 is a block diagram of an embodiment of an imaging device shown in FIG. 1.

FIG. 4 is a flow diagram that illustrates an embodiment of operation of the system shown in FIG. 1 in controlling the configuration of imaging devices.

FIG. 5 is a flow diagram that illustrates an embodiment of operation of a configuration manager of the central computing device shown in FIG. 2.

FIG. 6 is a flow diagram that illustrates an embodiment of operation of a configuration reporting module of the imaging device shown in FIG. 3.

### DETAILED DESCRIPTION

Disclosed herein are systems and methods through which the configuration of an imaging device can be controlled. In particular, the configuration of a plurality of imaging devices of a given group may be evaluated and, if necessary, reconfigured. Example systems are first discussed with reference to the figures. Although these systems are described in detail, they are provided for purposes of illustration only and various modifications are feasible. After the example systems have been described, examples of operation of the systems are provided to explain the manners in which configuration control can be achieved.

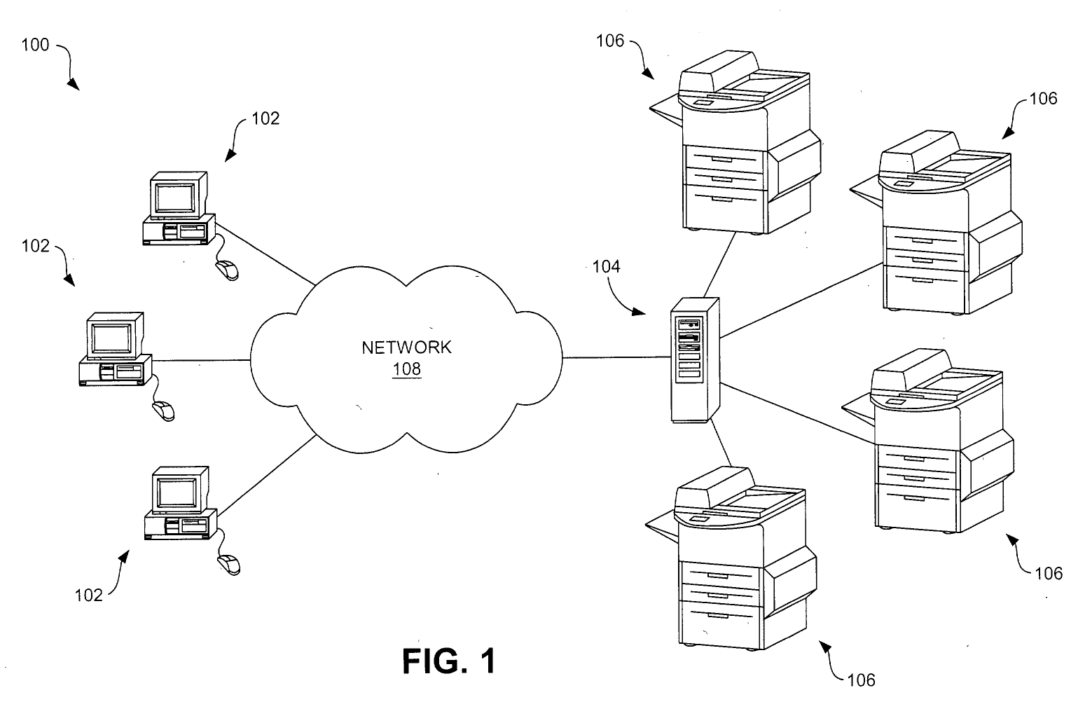

Referring now in more detail to the figures in which like numerals identify corresponding parts, FIG. 1 illustrates an example system 100 in which imaging device configuration can be evaluated and reconfigured. As indicated in this figure, the system 100 generally comprises one or more user computing devices 102, a central computing device 104, and several imaging devices 106. As shown in FIG. 1, the user computing devices 102 can, for instance, comprise desktop personal computers (PCs). Each of these user computing devices 102 may communicate with the imaging devices 106 via the central computing device 104.

As indicated in FIG. 1, the user computing devices 102 may communicate to the central computing device 104 via a network 108, however, direct communications between the user computing devices and the central computing device are possible. Where a network 108 is used, the network may comprise one or more sub-networks that are communicatively coupled to each other. By way of example, these networks can include one or more local area networks (LANs) and/or wide area networks (WANs). Although the user computing devices 102 are illustrated as communicating to the imaging devices 106 through the central computing device 104, one or more of the user computing devices may, optionally, be directly connected (either through a cable or wirelessly) to one or more of the imaging devices.

Where, as in the example of FIG. 1, the central computing device 104 acts as a hub for the various imaging devices 106, the central computing device may comprise a print server computer that routes print jobs from the user computing devices 102 to the imaging devices 106. More generally, however, the central computing device 104 comprises a computing device that is in communication with each of the imaging devices 106 so that each may be evaluated and reconfigured as desired.

The imaging devices 106 comprise substantially any device that can receive data and generate hardcopy outputs based upon the received data. As indicated in FIG. 1, the imaging devices 106 may comprise printers. Although printers are illustrated in FIG. 1 and have been explicitly identified herein, the imaging devices may be other devices including, for example, photocopying devices, multi-function peripheral (MFP) devices (also referred to as “all-in-one” devices), facsimile devices, etc. Normally, each of the imaging devices 106 of a group (a group of four being depicted in FIG. 1) are of the same make and model. In alternative arrangements, however, the imaging devices 106 may be different.

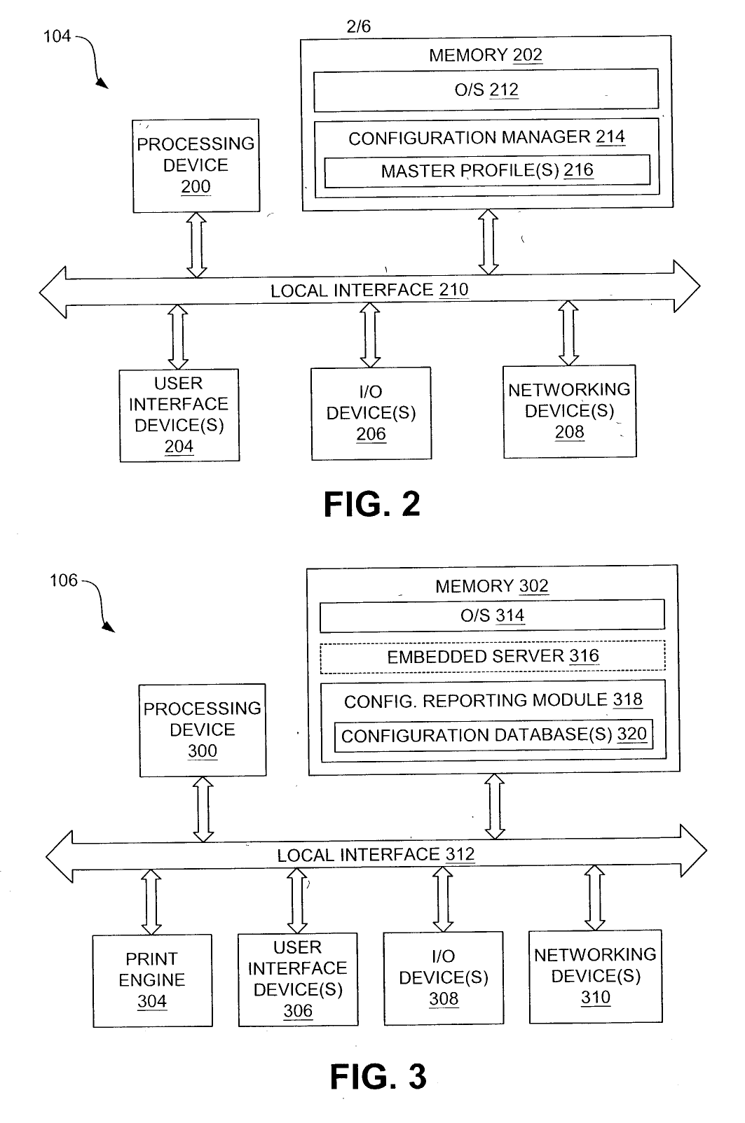

FIG. 2 is a block diagram illustrating an example architecture for the central computing device 104 shown in FIG. 1. As indicated in FIG. 2, the central computing device 104 comprises a processing device 200, memory 202, one or more user interface devices 204, one or more input/output (I/O) devices 206, and one or more networking devices 208, each of which is connected to a local interface 210. The processing device 200 can include any custom made or commercially available processor, a central processing unit (CPU) or an auxiliary processor among several processors associated with the central computing device 102, a semiconductor based microprocessor (in the form of a microchip), or a macroprocessor. The memory 202 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 204 comprise those components with which the user (e.g., administrator) can interact with the central computing device 102. Where the central computing device 102 comprises a print server computer or similar device, these components can comprise those typically used in conjunction with a PC such as a keyboard and mouse.

The one or more I/O devices 206 comprise components used to facilitate connection of the central computing device to other devices and therefore, for instance, comprise one or more serial, parallel, small system interface (SCSI), universal serial bus (USB), or IEEE 1394 (e.g., Firewire™) connection elements. The networking devices 208 comprise the various components used to transmit and/or receive data over the network 108, where provided. By way of example, the networking devices 208 include a device that can communicate both inputs and outputs, for instance, a modulator/demodulator (e.g., modem), a radio frequency (RF) or infrared (IR) transceiver, a telephonic interface, a bridge, a router, as well as a network card, etc.

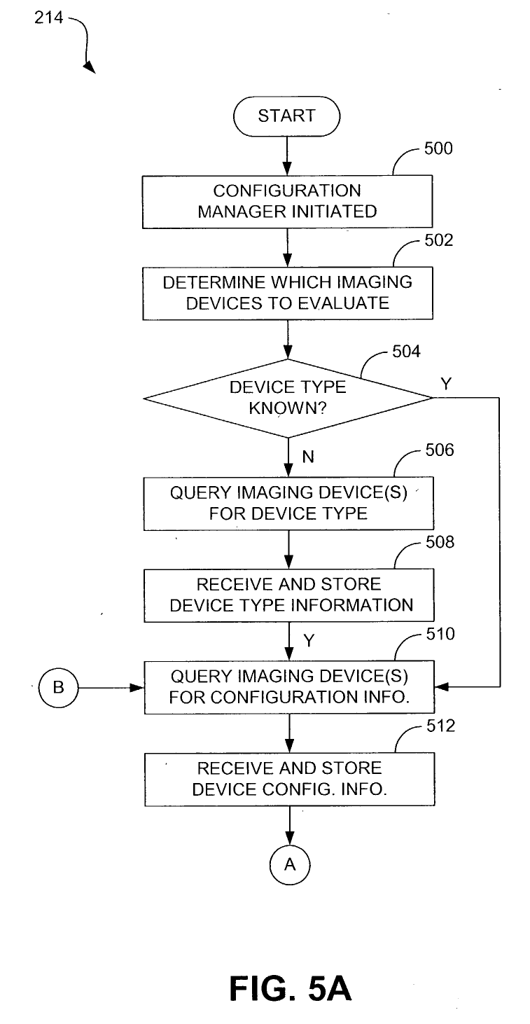

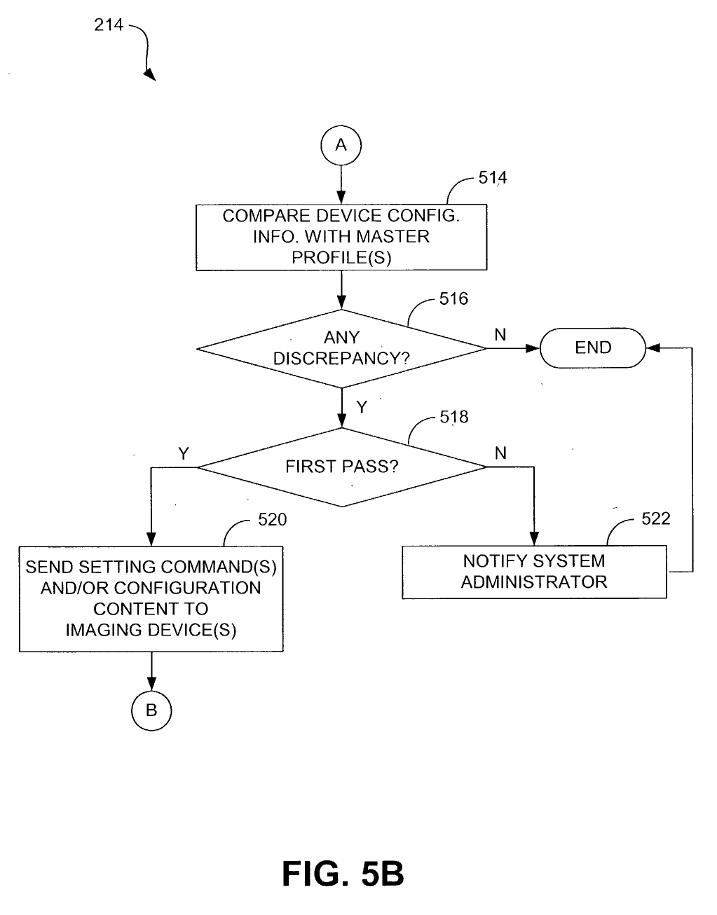

The memory 202 normally comprises various programs (in software and/or firmware) including an operating system (O/S) 212 and a configuration manager 214. The O/S 212 controls the execution of other programs and provides scheduling, input-output control, file and data management, memory management, and communication control and related services. The configuration manager 214 facilitates the imaging device configuration evaluation and reconfiguration processes. Typically, the evaluation process involves comparing the various settings and other configuration aspects of one or more imaging devices 106 with one or more master profiles 216. Operation of the configuration manager 214 is described in relation to FIGS. 4 and 5.

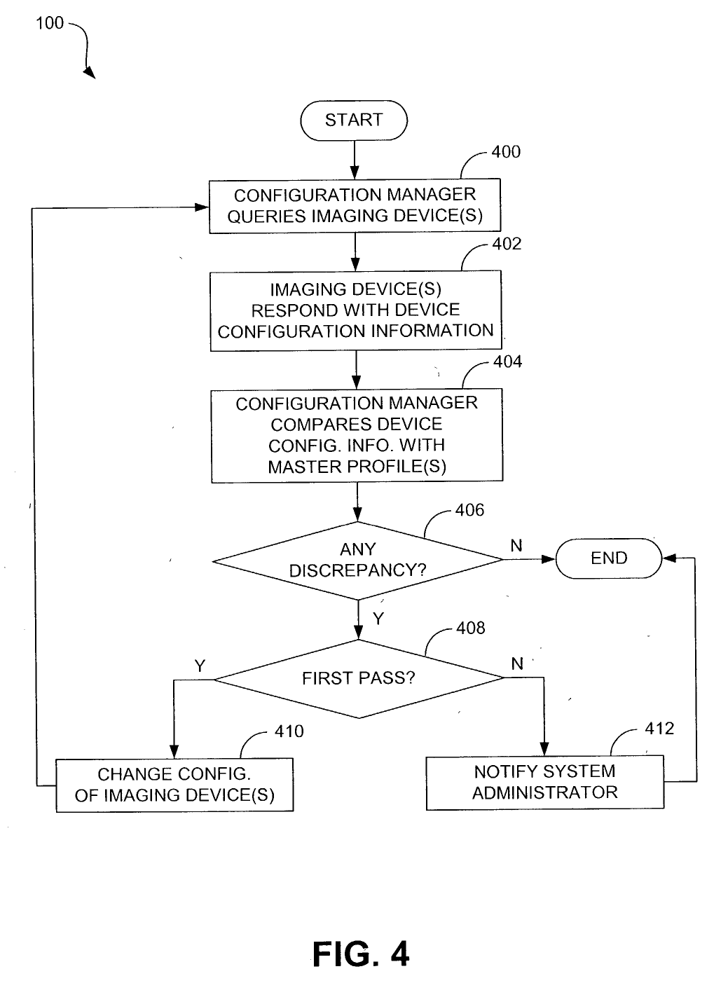

FIG. 3 is a block diagram illustrating an example architecture for the imaging devices 106 shown in FIG. 1. As indicated in FIG. 3, each imaging device 106 can comprise a processing device 300, memory 302, print engine 304, one or more user interface devices 306, one or more I/O devices 308, and one or more networking devices 310. Each of these components is connected to a local interface 312 that, by way of example, comprises one or more internal buses. The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the imaging device 106. The memory 302 can include any one or a combination of volatile memory elements (e.g., RAM) and nonvolatile memory elements (e.g., ROM, hard drive, etc.).

The print engine 304 comprises the components with which the imaging device 106 generates' hardcopy documents. This engine 304 can comprise, for instance, a paper drive mechanism, print engine, fusing system, etc. The one or more user interface devices 306 typically comprise the interface tools with which the device settings can be changed and through which the user can communicate commands to the imaging device 106. By way of example, the user interface devices 306 comprise one or more function keys and/or buttons with which the operation of the imaging device 106 can be controlled, and a display, such as a liquid crystal display (LCD), with which information can be visually communicated to the user and, if touch-sensitive, with which commands may be entered by the user. The I/O devices 308 and networking devices 310 can have configurations similar to that of like-named components identified above with reference to FIG. 2.

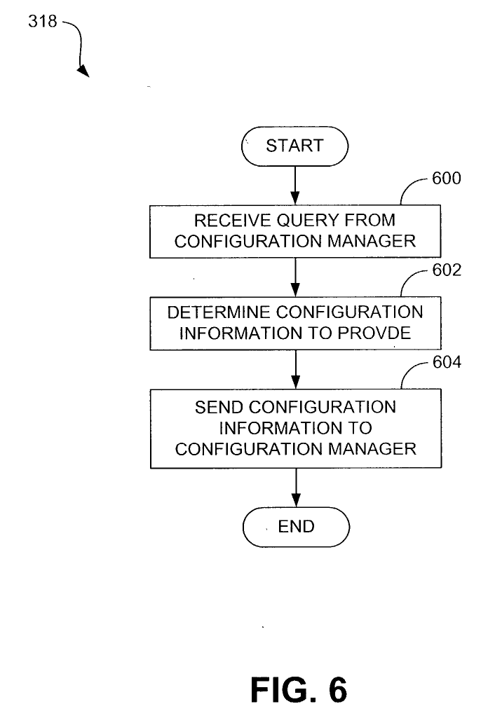

The memory 302 includes various programs (in software and/or firmware) including an O/S 314 that contains the various commands used to control the general operation of the imaging device 106. In addition, the memory 302 can, optionally, include an embedded network server 316 that generates one or more interface pages to which users may browse to change the device settings or evaluate device status. In addition, the memory 302 includes a configuration reporting module 318 that provides information about the current configuration of the imaging device 106 when requested (or affirmatively, as the case may be). By way of example, this configuration information is collected from one or more configuration databases 320. Operation of the configuration reporting module 318 is described with respect to FIGS. 4 and 6 below.

Various programs have been described above. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussions that follow, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 4 illustrates a high-level example of operation of the system 100 in evaluating the configuration of imaging devices and reconfiguring them as needed. Beginning with block 400, the configuration manager 214 queries one or more imaging devices for their configuration. The imaging devices may comprise those used in a group such as a test center or a printing pool. By way of example, the configuration may include any setting or selection that has been entered using a front menu panel of any imaging device or any setting or selection that has been entered using an interface page served by an embedded network server of an imaging device. Therefore, configuration information may pertain to font settings, media size settings, media type settings, simplex or duplex printing, scaling settings, number of copies, etc. In addition, the configuration information may pertain to other configuration aspects such as firmware version executing in the device, network configuration, and so forth.

Once the imaging devices have been queried, they respond with device configuration information, as indicated in block 402. As described in greater detail below, this information may comprise individual pieces of information (e.g., information regarding individual settings) or state information that includes information as to all configuration details. After the configuration information is sent back to the configuration manager 214, the manager compares the received information with one or more master profiles 216 that pertain to the imaging devices, as indicated in block 404. In particular, the settings and other configuration aspects of the various imaging devices are compared with desired configuration details specified in the master profiles 216. Where only one type of imaging device is being evaluated, the configuration information may be compared with a single master profile. Where different types of imaging devices are implicated, however, the information received from each different type of device is compared to a master profile specifically intended for that device type.

At this point, the configuration manager 214 determines whether any configuration discrepancies exist between one or more imaging devices and the configuration details specified in the relevant master profile, as indicated in decision block 406. If so, one or more settings have potentially been changed by a user and therefore should be reset to the desired setting. Alternatively, other configuration aspects (e.g., firmware version) may be incorrect and may require action. If no such discrepancy exists, the configurations are correct and flow for the session is terminated. If, on the other hand, a discrepancy is detected, flow continues to decision block 408 at which it is determined whether this is the first pass in the analysis, i.e. whether only one discrepancy determination has been made. If so, flow continues to block 410 at which the configuration of one or more of the imaging devices is changed (e.g., by changing one or more device settings inline with one or more master profiles).

At this point, flow returns to block 400 at which the evaluation process is again performed to ensure that the configurations are now in accord with those of the master profile(s). Flow therefore continues in the manner described above. If decision block 408 is again reached, the discrepancy presumably was not corrected in block 410, and flow continues to block 412 at which a system administrator (e.g., technician or information technology (IT) professional) is notified of the situation. By way of example, such an occurrence may identify a separate problem such as a firmware or print driver defect that the administrator may need to remedy.

FIGS. 5A and 5B provide an example of operation of the configuration manager 214 in facilitating evaluation and reconfiguration of imaging devices. Beginning with block 500 of FIG. 5A, the configuration manager 214 is initiated. This initiation can occur in response to various different events. In one case, initiation occurs in response to a command received from the administrator. For instance, if the administrator learns that unexpected printing results are occurring and suspects that one or more settings have been changed, the administrator can initiate the evaluation/reconfiguration process. In another case, initiation can occur at a scheduled time in situations in which the imaging devices are to be evaluated on a periodic basis (e.g., at the beginning of each business day).

In any case, the configuration manager 214 next determines which imaging devices to evaluate, as indicated in block 502. This determination can be based, for example, upon a predefined setting in which the manager 214 is directed to evaluate a given group of imaging devices (i.e., administrator controlled). Alternatively, the configuration manager 214 can be programmed to identify all of the imaging devices of a given type (make and model) to which the manager has access, either directly or via a network. In yet another alternative, the configuration manager 214 can be programmed to identify all of the imaging devices of a particular grouping (e.g., test center or printing pool), for instance by detecting an identifier included in the devices' addresses.

Next, with reference to decision block 504, it is determined whether the types of the imaging devices are known. Assuming the imaging devices to evaluate where identified to the manager 214 by a predefined setting or determined by the manager by identifying all the devices of a given type, the device type is known and flow continues to block 510 described below. If the type is not known, however, for instance if the configuration manager 214 identified several devices of a given group, flow continues to block 506 at which the imaging devices are queried for their respective types. Once these queries are sent, device type information sent by the imaging devices can be received and stored, as indicated in block 508.

With reference to block 510, the configuration manager 214 queries the imaging devices for their configuration information. As described above in reference to FIG. 4, this information can pertain to substantially any settings of the devices including, for instance, font settings, media size settings, media type settings, simplex or duplex printing, scaling settings, number of copies, firmware version, network configuration, etc. In some cases, information regarding each configuration aspect to be evaluated may be queried for separately. For example, such queries can be made in the form of printer management language (PML) commands or, in network-based arrangements, in the form of simple network management protocol (SNMP) commands. In such a situation, the query comprises a request regarding a particular value. For instance, to determine what contrast level of the courier font is being used, a request is made for the setting of 1.3.3.1.38 (indicating dark-courier). In other cases, the queries can comprise requests for state information (e.g., a state tree) from each of the imaging devices such that all configuration information for each imaging device is requested by the configuration manager 214.

Referring now to FIG. 6 and block 600, which illustrates operation of the configuration reporting module 318 of an imaging device, the query is received from the configuration manager 214. Next, the reporting module 318 determines what configuration information is to be provided, as indicated in block 602, whether it be one or more individual pieces of information or all state information. Once this determination is made, the reporting module 318 sends the configuration information to the configuration module 214, as indicated in block 604.

For cases in which all state information has been requested by the configuration manager 214, several individual PML or SNMP commands can be used to communicate the state information from the device or the device configuration information can be organized into a file to be sent to the manager. For example, the information can be organized into an extensible markup language (XML) file or tree such as the following:

<?xml version=″1.0″ encoding=“UTF-8” ?>
<Printing>

<Courier>

<value >1</value>

</Courier>

</Printing>

In this example, the <Printing> tag identifies the tree and <Courier> would be the element and its current setting. The “1” indicates the imaging device would be using a relatively light setting, whereas a “2” would indicate a darker setting. In the typical case, the XML tree contains many more tags than just <Courier>. For example, the tree could further include tags for various other configuration aspects such as media type, media size, manual feed, etc.

Returning to FIG. 5A, the configuration information from the imaging devices is then received and stored, as indicated in block 512. With reference next to block 514 of FIG. 5B, the received information is compared to the information contained in the master profile or profiles. At this point, the configuration manager 214 determines whether any discrepancies exist between one or more settings or other configuration aspects of the imaging devices and those specified in the relevant master profile, as indicated in decision block 516.

If a discrepancy is not discovered, all the imaging devices are correctly configured and no further action is necessary. If, on the other hand, a discrepancy is detected, flow continues to decision block 518 at which it is determined whether this is the first pass in the analysis. If so, it is the first time the analysis has been conducted and flow continues to block 520 at which setting commands and/or configuration content is sent to the imaging devices in which a discrepancy was detected. Again, the commands may simply comprise individual commands (e.g., PML or SNMP commands) to change various individual device settings. In keeping with the previous font-based example, the imaging device may be commanded to use dark courier font by sending the value 1.3.3.1.38.2 to the imaging device. Alternatively, the commands can be provided as a collection of commands (e.g., an XML tree) which changes all of the settings of the imaging devices to mirror those of the relevant master profile.

Where the discrepancy pertains to a configuration aspect other than a setting or other feature that may be corrected with a mere command, for instance where the firmware version of an imaging device is incorrect (e.g., outdated), configuration content may be sent to the imaging device. By way of example, where the firmware version is incorrect, a copy of the correct firmware may be contained within the configuration manager 214 or may be accessed by the manager, for instance by accessing a Web site of the imaging device manufacturer. Accordingly, it can be appreciated that, if desired, the configuration manager 214 can not only be used to reconfigure incorrectly configured imaging devices, but can also be used as a tool to update firmware used within the devices. In such a scenario, firmware updating can be achieved for all imaging devices of the group by simply updating the master profile to either specify a new version of the firmware, or an address to that may be accessed to check for the latest firmware updates.

At this point, flow returns to block 510 of FIG. 5A at which the evaluation process is again performed to ensure that the configurations are now in accord with those of the master profile(s). Flow therefore continues in the manner described above. If decision block 518 of FIG. 5B is again reached, the discrepancy presumably was not corrected in block 520, and flow continues to block 522 at which a system administrator is notified of the situation.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for controlling an imaging device, comprising:
querying the imaging device for configuration information;
receiving the configuration information from the imaging device;
comparing the configuration information to a master profile for the imaging device; and
determining if there are any discrepancies between the configuration information and information contained in the master profile.

2. The method of claim 1, wherein the step of querying comprises separately querying the imaging device about different configuration aspects.

3. The method of claim 1, wherein the step of querying comprises requesting substantially all state information from the imaging device.

4. The method of claim 1, wherein the step of receiving comprises receiving separate pieces of configuration information from the imaging device.

5. The method of claim 1, wherein the step of receiving comprises receiving a configuration file containing substantially all configuration information for the imaging device.

6. The method of claim 1, further comprising sending individual commands regarding device settings to the imaging device if a discrepancy is discovered.

7. The method of claim 1, further comprising sending a configuration file to the imaging device that identifies substantially all device configuration aspects to the imaging device if a discrepancy is discovered.

8. The method of claim 1, further comprising sending configuration content to the imaging device if a discrepancy is discovered.

9. The method of claim 1, further comprising facilitating correction of the imaging device configuration and querying the device a second time to determine whether the configuration is now correct.

10. A method for evaluating and reconfiguring imaging devices of a group, comprising:
determining whether the imaging devices are correctly configured; and
automatically correcting any incorrectly configured imaging devices in the group.

11. The method of claim 10, wherein the step of determining comprises querying the imaging devices for configuration information and receiving configuration information from each imaging device.

12. The method of claim 11, wherein the step of determining further comprises comparing the received configuration information with at least one master profile that contains correct configuration information.

13. The method of claim 10, wherein the step of receiving comprises receiving configuration files from the imaging devices containing substantially all configuration information for each device.

14. The method of claim 10, wherein the step of correcting comprises sending individual setting commands to imaging devices having one or more incorrect settings.

15. The method of claim 10, wherein the step of correcting comprises sending configuration files to imaging devices having one or more incorrect settings.

16. The method of claim 10, wherein the step of correcting comprises facilitating sending of firmware to imaging devices having incorrect firmware.

17. The method of claim 10, further comprising querying the imaging devices a second time to determine whether their configurations are now correct.

18. A system for controlling imaging devices, comprising:
a configuration manager that is configured to query imaging devices for configuration information and to compare received configuration information with information contained within a master profile so that the manager can determine whether the imaging devices are correctly configured; and
a configuration reporting module that is configured to receive configuration queries and provide configuration information in response.

19. The system of claim 18, wherein the configuration manager is further configured to facilitate correction of imaging device configurations if an incorrect configuration is discovered.

20. The system of claim 19, wherein the configuration manager is further configured to requery imaging devices whose configuration change has been facilitated to evaluate whether the imaging devices have the correct configuration.

21. The system of claim 19, wherein the configuration manager is further configured to send setting change commands to imaging devices that are incorrectly configured.

22. The system of claim 19, wherein the configuration manager is further configured to facilitate sending of firmware updates to imaging devices having incorrect firmware.

23. A configuration manager for evaluating and reconfiguring imaging devices, the manager stored on a computer-readable medium, the manager comprising:
logic configured to query imaging devices of a given group of imaging devices;
logic configured to compare configuration information received from the imaging devices to a master profile that contains desired configuration details;
logic configured to determine if an imaging device is incorrectly configured in view of the comparison; and
logic configured to correct any incorrectly configured imaging devices in the group.

24. The configuration manager of claim 23, wherein the logic configured to correct comprises logic configured to send separate setting change commands for any settings that are incorrect.

25. The configuration manager of claim 23, wherein the logic configured to correct comprises logic configured to send a configuration file to an imaging device, the file comprising substantially all configuration information for the imaging device.

26. The configuration manager of claim 23, wherein the logic configured to correct comprises logic configured to facilitate downloading of firmware to an imaging device.

27. A computing device, comprising:
a processing device; and
memory that includes a configuration manager for evaluating and reconfiguring imaging devices, the configuration manager including logic configured to query imaging devices of a given group of imaging devices, logic configured to compare configuration information receiving from the imaging devices to a master profile that contains desired configuration details, logic configured to determine if an imaging device is incorrectly configured in view of the comparison, and logic configured to correct any incorrectly configured imaging devices in the group.

28. The device of claim 27, wherein the logic configured to correct comprises logic configured to send setting change commands to an imaging device.

29. The device of claim 27, wherein the logic configured to correct comprises logic configured to facilitate downloading of firmware to an imaging device.

30. A system for controlling imaging devices, comprising:
means for querying the imaging devices for configuration information;
means for comparing received configuration information with information contained within a master profile; and
means for reconfiguring imaging devices that have configuration discrepancies in view of the master profile.
